(19) United States
(12) Patent Application Publication
(10) Pub. No.: US 2026/0110837 A1
(43) Pub. Date: Apr. 23, 2026

(54) PHOTONIC DEVICES AND STRUCTURES FOR OPTICAL EPOXY/OIL OVERFLOW CONTROL

(71) Applicant: II-VI Delaware, Inc., Wilmington, DE (US)

(72) Inventors: Yao Sun, Shanghai (CN); Jianhu Wei, Shanghai (CN); Po Dong, Freemont, CA (US); Michael Kossey, Belmar, NJ (US); Wei Si, Shanghai (CN); Shanshan Zeng, Shanghai (CN); Jiameng Du, Shanghai (CN); Juan Hu, Shanghai (CN)

(21) Appl. No.: 18/919,720

(22) Filed: Oct. 18, 2024

(51) Int. Cl. G02B 6/12; G02B 6/136

(52) U.S. Cl. CPC G02B 6/12004; G02B 6/12002; G02B 6/136; G02B 2006/12073; G02B 2006/12102; G02B 2006/12111; G02B 2006/12114; G02B 2006/12147

(57) ABSTRACT

A photonic system includes a photonic device, a first set of bulk optics components, a second set of bulk optics components, and optical fill material. The photonic device includes a semiconductor substrate, a dielectric layer, a first set of optical ports, a second set of optical ports, and one or more overflow structure between the first and second set of optical ports. The semiconductor substrate includes a top side, a bottom side, and a lateral side. The dielectric layer includes a top side, a bottom side on the top side of the semiconductor substrate, and a lateral side. The optical fill material fills a first interface between the first set of bulk optics components and the first set of optical ports. The one or more overflow structures provide one or more voids to receive optical fill material that overflows from the first interface.

### TECHNICAL FIELD Aspects of the present disclosure are related to photonic devices such as photonic integrated circuit (PIC) devices and methods of manufacturing photonic devices.

### BACKGROUND

Photonic integrated circuit (PIC) devices are usually fabricated using a bulk silicon substrate and a dielectric layer that includes various photonic structures. For example the dielectric layer may include photonic edge couplers or optical ports. Such optical ports may couple the photonic structures of the PIC device to external bulk optics components (e.g., optical fibers, lenses, prisms, etc.).

Optical fill material such epoxy or oil is often used to enlarge the modal field of the optical port to provide better coupling efficiency and/or to reduce optical reflection between the optical port and the bulk optics components. The process of applying optical fill material between the optical port and bulk optics components is usually referred as epoxy/oil filling. A photonic device may include a first set of optical ports that require filling an interface between the first set of optical ports and a first set of bulk optics components with optical fill material. A photonic device may also include a second set of optical ports that require an interface between the second set of optical ports and a second set of bulk optics components to remain free of optical fill material. For example, the interface to laser ports may be required to be free of optical fill material, while the interface to fiber ports may need to be filled with optical fill material. However, the first set of optical ports may be in close proximity to the second set of optical ports, making it difficult to properly fill a first interface of the first set of optical ports without optical fill material overflowing from the first interface and into a second interface of the second set of optical ports, thus negatively affecting the coupling between the second set of optical ports and their respective bulk optics components.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY OF THE DISCLOSURE

Shown in and/or described in connection with at least one of the figures, and set forth more completely in the claims, are photonic devices and associated processes for manufacturing photonic devices. Various embodiments of the present disclosure may provide overflow structures (e.g., bucket, block, and/or shelf structures) between a first set of optical ports and second set of optical ports. Such overflow structures may help prevent optical fill material used to fill a first interface between a first set of optical ports and a first set of bulk optics components from overflowing into a second interface between a second set of optical ports and a second set of bulk optics components. In this manner, the overflow structures may aid in keeping the second interface clear of optical fill material.

These and other advantages, aspects and novel features of the present disclosure, as well as details of illustrated embodiments thereof, will be more fully understood from the following description and drawings.

### BRIEF DESCRIPTION OF THE DRAWINGS

Various features and advantages of the present disclosure may be more readily understood with reference to the following detailed description taken in conjunction with the accompanying drawings, wherein like reference numerals designate like structural elements.

FIG. 1A depicts a plan view of a photonic device comprising bucket structures between sets of optical ports.

FIG. 1B depicts a perspective view of an edge or lateral portion of the photonic device of FIG. 1A.

FIG. 2A depicts a plan view of a photonic device comprising block structures between sets of optical ports.

FIG. 2B depicts a perspective view of an edge or lateral portion of the photonic device of FIG. 2A.

FIG. 3A depicts a plan view of a photonic device comprising bucket structures and block structures between sets of optical ports.

FIG. 3B depicts a perspective view of an edge or lateral portion of the photonic device of FIG. 3A.

FIG. 4 depicts a flowchart for manufacturing the photonic devices of FIGS. 1A-3B.

### DESCRIPTION

The following discussion provides various examples of photonic systems, photonic devices (e.g., photonic integrated circuit (PIC) devices), and associated processes for manufacturing photonic devices. Such examples are non-limiting, and the scope of the appended claims should not be limited to the particular examples disclosed. In the following discussion, the terms “example” and “e.g.” are non-limiting.

In some embodiments, photonic devices are provides with on-chip, overflow structures. Such overflow structures may help prevent or reduce the likelihood of optical fill material overflowing from a first interface for a first set of optical ports to a second interface for a second set of optical ports when filling the first interface with optical fill material. In this manner, the overflow structures may improve the manufacturability of photonic devices having interfaces with different optical fill material needs (e.g., some interfaces that requiring optical fill material, and some interfaces that need to remain free optical fill material) and/or may reduce reliability concerns associated with overflowing optical fill material.

The figures illustrate a general manner of construction. Descriptions and details of well-known features and techniques may be omitted to avoid unnecessarily obscuring the present disclosure. In addition, elements in the drawing figures are not necessarily drawn to scale. For example, the dimensions of some of the elements in the figures may be exaggerated relative to other elements to help improve understanding of the examples discussed in the present disclosure. The same reference numerals in different figures denote the same elements.

The term “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”.

The terms “comprises,” “comprising,” “includes,” and/or “including,” are “open ended” terms and specify the presence of stated features, but do not preclude the presence or addition of one or more other features.

The terms “first,” “second,” etc. may be used herein to describe various elements, and these elements should not be limited by these terms. These terms are only used to distinguish one element from another. Thus, for example, a first element discussed in this disclosure could be termed a second element without departing from the teachings of the present disclosure.

Unless specified otherwise, the term “coupled” may be used to describe two elements directly contacting each other or describe two elements indirectly connected by one or more other elements. For example, if element A is coupled to element B, then element A can be directly contacting element B or indirectly connected to element B by an intervening element C. Similarly, the terms “over” or “on” may be used to describe two elements directly contacting each other or describe two elements indirectly connected by one or more other elements.

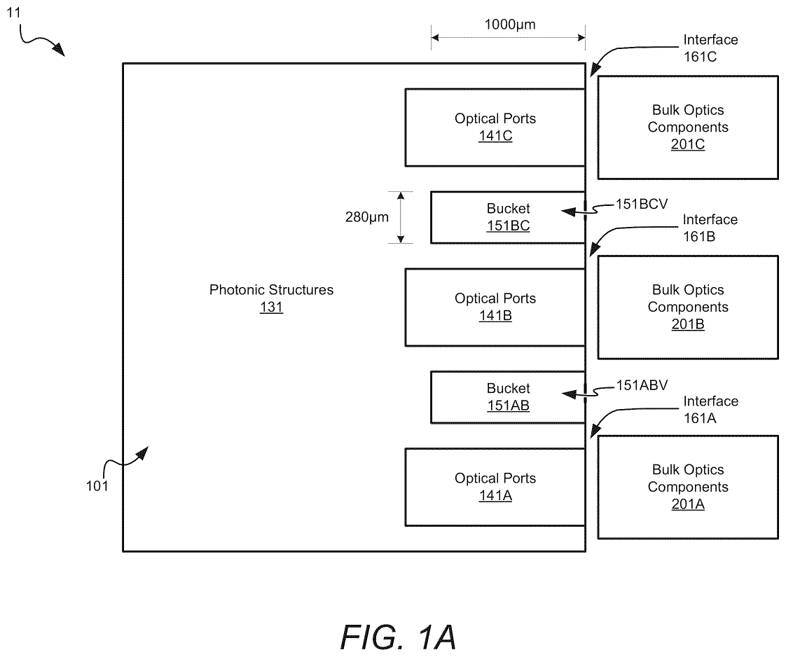

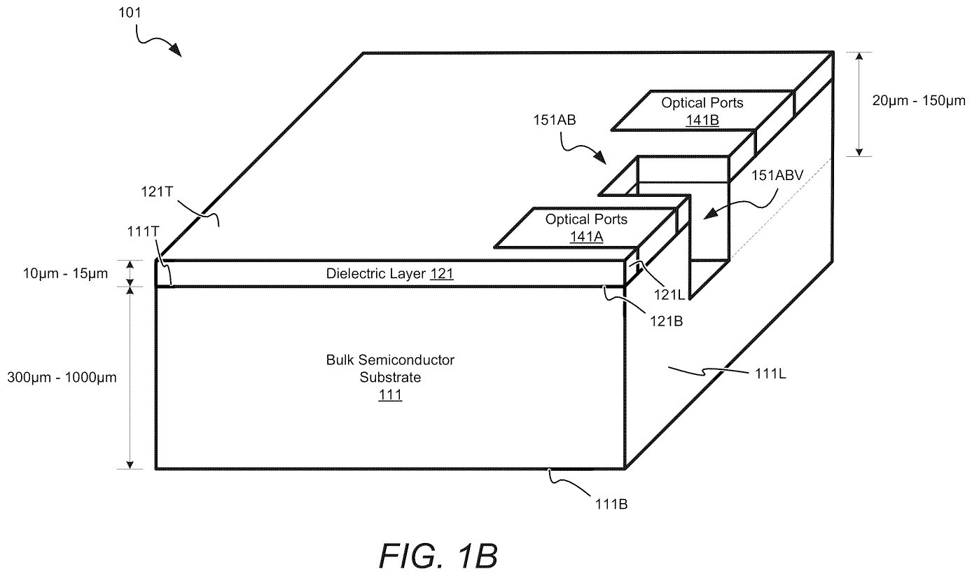

Referring now to the plan and perspective views of FIGS. 1A and 1B, a photonic system 11 and photonic device 101 are shown. In particular, FIG. 1A provides a plan view of the photonic system 11. As shown, the photonic system 11 may include a photonic device 101 and sets of bulk optics components 201A, 201B, 201C coupled to the photonic device 101 via respective interfaces 161A, 161B, 161C.

FIG. 1B provides a perspective view of a lateral portion of the photonic device 101 of the photonic system 11. As shown, the photonic device 101 may include a bulk semiconductor substrate 111 and a dielectric layer 121 over the bulk semiconductor substrate 111. The semiconductor substrate 111 may include a semiconductor substrate top side 111T, a semiconductor substrate bottom side 111B, and one or more substrate lateral sides 111L between the semiconductor substrate top side 111T and the semiconductor substrate bottom side 111B. Similarly, the dielectric layer 121 may include a dielectric top side 121T, a dielectric bottom side 121B, and one or more dielectric lateral sides 121L between the dielectric top side 121T and the dielectric bottom side 121B. The dielectric bottom side 121B may cover and contact the semiconductor substrate top side 111T.

The dielectric layer 121 of the photonic device 101 may include photonic structures 131 and sets of photonic edge couplers or optical ports 141A, 141B, 141C. The photonic structures 131 may include one or more passive photonic structures such as gratings, waveguides, etc. Alternatively and/or additionally, the photonic structures 131 may include one or more active photonic structures such as, for example, lasers, polarizers, phase shifters, photodetectors (PD), etc. that generate, detect, transport, and process photons (i.e., light).

The sets of optical ports 141A, 141B, 141C may be positioned along and/or extended to one or more lateral sides of the photonic device 101. Further, each set of optical ports 141A, 141B, 141C may include one or more optical ports, photonic edge couplers, and/or channels, hereafter optical ports. Each optical port in a given set of optical ports 141A, 141B, 141C may have the same optical fill material requirement. For example, each optical port in the first set of optical ports 141A may require that its interface 161A to the first set of bulk optics components 201A be filled with optical fill material such as epoxy or oil. Similarly, each optical port in the third set of optical ports 141C may require that its interface 161C to the third set of bulk optics components 201C be filled with optical fill material. Conversely, each optical port in the second set of optical ports 141B may require that its interface 161B to the second set of bulk optics components 201B remain free of optical fill material.

For ease of illustration, only one lateral side of the photonic device 101 is depicted with optical ports. However, in some embodiments, the photonic device 101 may include optical ports along multiple lateral sides of the photonic device 101. Further, the photonic device 101 may include a different quantity of optical port sets.

To accommodate differences in optical fill material requirements, the photonic device 101 may include overflow structures that aid in preventing the flow of optical fill material between interfaces 161A, 161B, 161C of the photonic device 101. In particular, the photonic device 101 may include a first bucket structure 151AB between the first set of optical ports 141A and the second set of optical ports 141B. Moreover, the photonic device 101 may include a second bucket structure 151BC between the second set of optical ports 141B and the third set of optical ports 141C.

As shown in FIG. 1B, the first bucket structure 151AB provides a void 151ABV between the first set of optical ports 141A and the second set of optical ports 141B. The void 151ABV may provide space for overflowing optical fill material. For example, when filling the first interface 161A between the first set of optical ports 141A and the first set of bulk optics components 201A with optical fill material, the optical fill material may overflow the first interface 161A and flow toward the second interface 161B and the second set of optical ports 141B. Due to the first bucket structure 151AB, such optical fill material needs to essentially fill the void 151ABV provided by the bucket structure 151AB in order to traverse the bucket structure 151AB and reach the second interface 161B between the second set of optical ports 141B and the second set of bulk optics components 201B. In this manner, the first bucket structure 151AB may provide extra tolerance for filling the first interface 161A with optical fill material and reduce the likelihood of inadvertently applying optical fill material to the second interface 161B in the process. Similarly, the second bucket structure 151BC may provide extra tolerance for filling the third interface 161C between the third set of optical ports 141C and the third set of bulk optics components 201C with optical fill material and reduce the likelihood of inadvertently applying optical fill material to the second interface 161B in the process.

As shown in FIG. 1B, the bulk semiconductor structure 111 may have a vertical depth of about 300 μm to about 1000 μm and the dielectric layer 121 may have a vertical depth of about 10 μm to about 15 μm. In various embodiments, the voids 151ABV, 151BCV provided by the bucket structures 151AB, 151BC may extend vertically through the dielectric top side 121T and through the semiconductor substrate top side 111T to a vertical depth of about 20 μm to about 150 μm. As shown in FIG. 1A, the voids 151ABV, 151BCV provided by the bucket structures 151AB, 151BC may extend laterally into the dielectric layer 121 and bulk semiconductor substrate 111 from a dielectric lateral side 121L and corresponding substrate lateral side 111L by about 1000 μm. Furthermore, the voids 151ABV, 151BCV provided by the bucket structures 151AB, 151BC may extend longitudinal along the dielectric lateral side 121L and substrate lateral side 111L by about 280 μm.

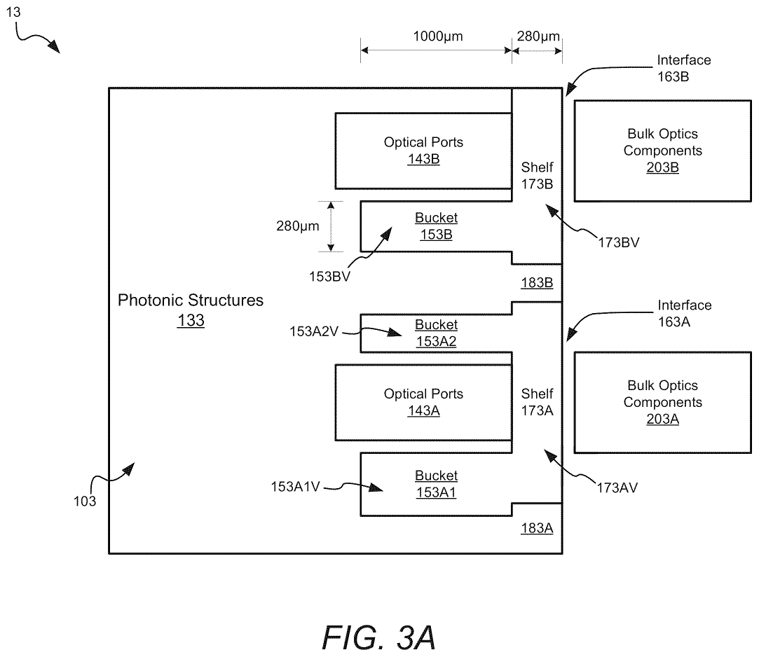

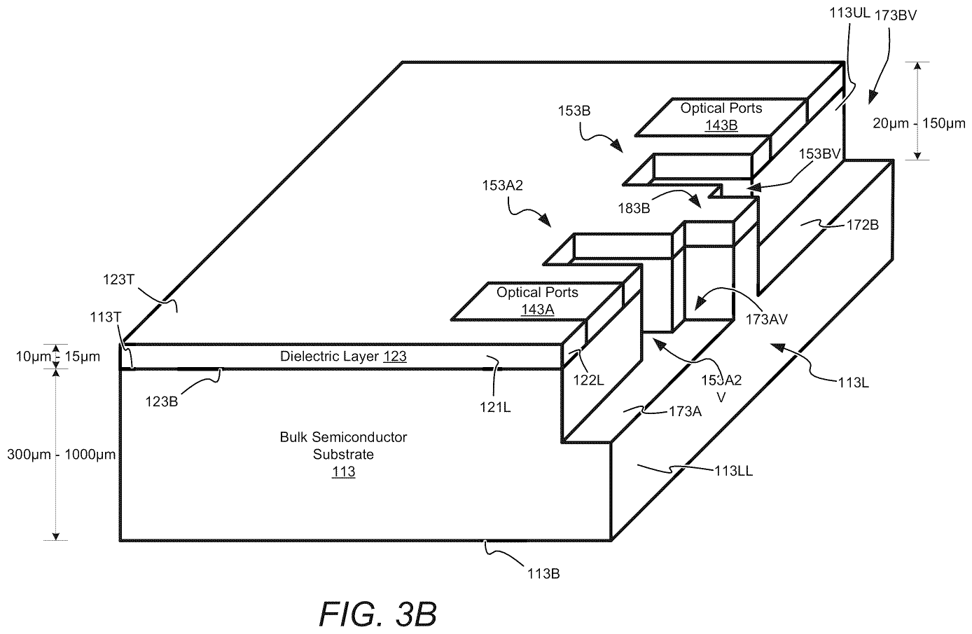

The above dimensions are primarily provided for context. The shape, dimensions, and quantity of the bucket structures may differ to accommodate various photonic device implementations. Moreover, while shown as being rectangular, the bucket structures may have irregular shapes. For example, a bucket structure may have an inlet portion at the substrate lateral side 111L with a narrower longitudinal opening than a main bucket portion. See, e.g., bucket structure 153A1 of FIG. 3A.

In general, the bucket structures are made as large as possible for given space constraints. However, there are practical upper and lower limits for such dimensions. For example, dimensions greater than 2000 μm may create mechanical stability concerns. For example, if the bucket structure is too large, the photonic device 101 may become prone to cracking. Conversely, if the bucket structure is too small, then the bucket structure is unable to provide a void with sufficient volume for receiving overflowing optical fill material and providing a desired level of overflow protection.

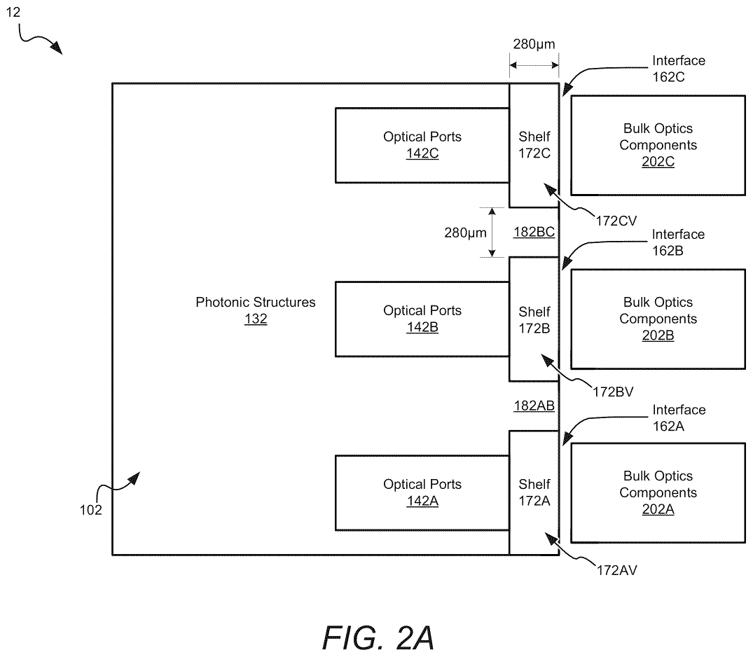

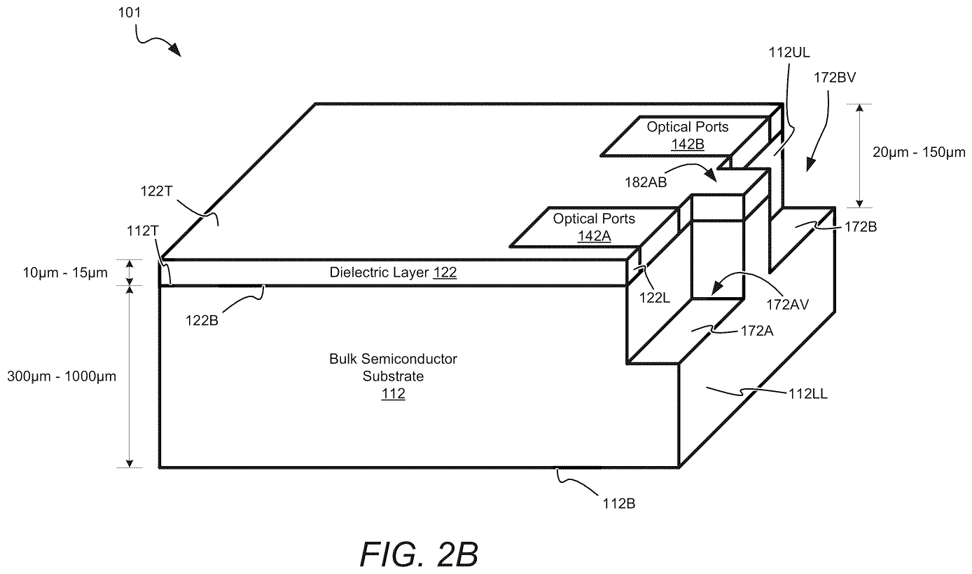

Referring now to the plan and perspective views of FIGS. 2A and 2B, a photonic system 12 and photonic device 102 are shown. In particular, FIG. 2A provides a plan view of the photonic system 12. As shown, the photonic system 12 may include the photonic device 102 and sets of bulk optics components 202A, 202B, 202C coupled to the photonic device 102 via respective interfaces 162A, 162B, 162C.

FIG. 2B provides a perspective view of a lateral portion of the photonic device 102 of the photonic system 12. As shown, the photonic device 102 may include a bulk semiconductor substrate 112 and a dielectric layer 122 over the bulk semiconductor substrate 112. The semiconductor substrate 112 may include a semiconductor substrate top side 112T, a semiconductor substrate bottom side 112B, and one or more substrate lateral sides 112L between the semiconductor substrate top side 112T and the semiconductor substrate bottom side 112B. Similarly, the dielectric layer 122 may include a dielectric top side 122T, a dielectric bottom side 122B, and one or more dielectric lateral sides 122L between the dielectric top side 122T and the dielectric bottom side 122B. The dielectric bottom side 122B may cover and contact the semiconductor substrate top side 112T.

The dielectric layer 122 of the photonic device 102 may include photonic structures 132 and sets of optical ports 142A, 142B, 142C. The photonic structures 132 may include one or more passive photonic structures such as gratings, waveguides, etc. Alternatively and/or additionally, the photonic structures 132 may include one or more active photonic structures such as, for example, lasers, polarizers, phase shifters, photodetectors (PD), etc. that generate, detect, transport, and process photons (i.e., light).

The sets of optical ports 142A, 142B, 142C may be positioned along and/or extended to one or more lateral sides of the photonic device 102. Further, each set of optical ports 142A, 142B, 142C may include one or more optical ports. Each optical port in a given set of optical ports 142A, 142B, 142C may have the same optical fill material requirement. For example, each optical port in the first set of optical ports 142A may require that its interface 162A to the first set of bulk optics components 202A be filled with optical fill material. Similarly, each optical port in the third set of optical ports 142C may require that its interface 162C to the third set of bulk optics components 202C be filled with optical fill material. Conversely, each optical port in the second set of optical ports 142B may require that its interface 162B to the second set of bulk optics components 202B remain free of optical fill material.

For ease of illustration, only one lateral side of the photonic device 102 is depicted with optical ports. However, in some embodiments, the photonic device 102 may include optical ports along multiple lateral sides of the photonic device 102. Moreover, the photonic device 102 may include a different quantity of optical port sets.

To accommodate differences in optical fill material requirements, the lateral side of the photonic device 102 corresponding to the optical ports 142A, 142B, 142C may be tiered such that the optical ports 142A, 142B, 142C and associated upper portions 112UL of the substrate lateral side 112L are laterally inward of a lower portion 112LL of the substrate lateral side 112L. Such tiering positions shelf structures 172A, 172B, 172C under the sets of optical ports 142A, 142B, 142C. Further, the photonic device 102 may include a first block structure 182AB between the first shelf structure 172A below the first set of optical ports 142A and the second shelf structure 172B below the second set of optical ports 142B. Similarly, the photonic device 101 may include a second block structure 182BC between the second shelf structure 172B below the second set of optical ports 142B and the third shelf structure 172C below the third set of optical ports 142C.

As shown FIG. 2B, the first block structure 182AB separates a first void 172AV provided by the first shelf structure 172A from and a second void 172BV provided by the second shelf structure 172B. In this manner, the first shelf structure 172A may provide a first void 172AV below the first set of optical ports 142A, the second shelf structure 172B may provide a second void 172BV below the second set of optical ports 142B, and the first block structure 182AB may separate the first void 172AV from the second void 172BV. As such, the first void 172AV and/or the second void 172BV may provide space for overflowing optical fill material. For example, when filling the first interface 162A between the first set of optical ports 142A and the first set of bulk optics components 202A with optical fill material, the optical fill material may overflow the first interface 162A, flow into the first void 172AV provided by the first shelf structure 172A, and flow toward the second set of optical ports 142B. However, due to the first block structure 182AB, such optical fill material is blocked from traversing the first block structure 182AB and into second void 172BV provided by the second shelf structure 172B and the second interface 162B between the second set of optical ports 142B and the second set of bulk optics components 202B. In this manner, the first block structure 182AB may provide extra tolerance for filling the first interface 162A and reduce the likelihood of inadvertently applying optical fill material to the second interface 162B in the process. Similarly, the second block structure 182BC may provide extra tolerance for filling the third interface 162C between the third set of optical ports 142C and the third set of bulk optics components 202C and reduce the likelihood of inadvertently applying optical fill material to the second interface 162B in the process.

As shown in FIG. 2B, the bulk semiconductor structure 112 may have a vertical depth of about 300 μm to about 1000 μm and the dielectric layer 122 may have a vertical depth of about 10 μm to about 15 μm. In various embodiments, the voids 172AV, 172BV, 172CV provided by the shelf structures 172A, 172B, 172C may extend vertically through the dielectric top side 122T and through the bulk semiconductor top side 112T to a vertical depth of about 20 μm to about 150 μm. As shown in FIG. 2A, the voids 172AV, 172BV, 172CV provided by the shelf structures 172A, 172B, 172C may extend laterally into the dielectric layer 122 and bulk semiconductor substrate 112 from a dielectric lateral side 122L and corresponding substrate lateral side 112L by about 280 μm. Furthermore, the block structures 182AB, 182BC may extend longitudinal along the dielectric lateral side 122L and substrate lateral side 112L and separate adjacent voids 172AV, 172BV, 172CV by about 280 μm.

In general, the voids 172AV, 172BV, 172CV provided by the shelf structures 172A, 172B, 172C are made as large as possible for given space constraints. However, there are practical upper and lower limits for such dimensions. For example, dimensions greater than 2000 μm may create mechanical stability concerns. For example, if the voids 172AV, 172BV, and 172CV are too large, the photonic device 102 may become prone to cracking. Conversely, if the voids 172AV, 172BV, 172CV are too small, then the voids 172AV, 172BV, 172CV may provide insufficient volume for receiving overflowing optical fill material and thus may fail to provide a desired level of overflow protection.

Referring now to the plan and perspective views of FIGS. 3A and 3B, a photonic system 13 and photonic device 103 are shown. In particular, FIG. 3A provides a plan view of the photonic system 13. As shown, the photonic system 13 may include the photonic device 103 and sets of bulk optics components 203A, 203B coupled to the photonic device 103 via respective interfaces 163A, 163B.

FIG. 3B provides a perspective view of a lateral portion of the photonic device 103 of the photonic system 13. The photonic device 103 may include a bulk semiconductor substrate 113 and a dielectric layer 123 over the bulk semiconductor substrate 113. The bulk semiconductor substrate 113 may include a semiconductor substrate top side 113T, a semiconductor substrate bottom side 113B, and one or more substrate lateral sides 113L between the semiconductor substrate top side 113T and the semiconductor substrate bottom side 113B. Similarly, the dielectric layer 123 may include a dielectric top side 123T, a dielectric bottom side 123B, and one or more dielectric lateral sides 123L between the dielectric top side 123T and the dielectric bottom side 123B. The dielectric bottom side 123B may cover and contact the semiconductor substrate top side 113T.

The dielectric layer 123 of the photonic device 103 may include photonic structures 133 and sets of optical ports 143A, 143B. The photonic structures 133 may include one or more passive photonic structures such as gratings, waveguides, etc. Alternatively and/or additionally, the photonic structures 133 may include one or more active photonic structures such as, for example, lasers, polarizers, phase shifters, photodetectors (PD), etc. that generate, detect, transport, and process photons (i.e., light).

The sets of optical ports 143A, 143B may be positioned along and/or extended to one or more lateral sides of the photonic device 103. Further, each set of optical ports 143A, 143B may include one or more optical ports. Each optical port in a given set of optical ports 143A, 143B may have the same optical fill material requirement. For example, each optical port in the first set of optical ports 143A may require that its interface 163A to the first set of bulk optics components 203A is filled with optical fill material. Further, each optical port in the second set of optical ports 143B may require that its interface 163B to the second set of bulk optics components 203B remain free of optical fill material.

For ease of illustration, only one lateral side of the photonic device 103 is depicted with optical ports. However, in some embodiments, the photonic device 103 may include optical ports along multiple lateral sides of the photonic device 103. Moreover, the photonic device 103 may include a different quantity of optical port sets.

To accommodate differences in optical fill material requirements, the lateral side of the photonic device 103 corresponding to the optical ports 143A, 143B may be tiered such that the optical ports 143A, 143B and corresponding portions of an upper portion 113UL of the substrate lateral side 113L are laterally inward of a lower portion 113LL of the substrate lateral side 113L. Such tiering positions shelf structures 173A, 173B under the sets of optical ports 143A, 143B. The photonic device 103 may also include a first block structure 183A to one side of the first set of optical ports 143A and a second block structure 183B between the first shelf structure 173A and the second shelf structure 173B.

As shown FIG. 3B, the first block structure 183B may separate a first void 173AV provided by the first shelf structure 173A from a second void 173BV provided by the second shelf structure 173B. In this manner, the first shelf structure 173A may provide the first void 173AV below the first set of optical ports 143A and the second shelf structure 173B may provide the second void 173BV below the second set of optical ports 143B. Further, the photonic device 103 may include a first bucket structure 153A1 and a second bucket structure 153A2 that flank the first set of optical ports 143A. Moreover, an inlet of the first bucket structure 153A1 and an inlet of the second bucket structure 153A2 may adjoin the first void 173AV provided by the first shelf structure 173A. As such, a first void 153A1V of the first bucket structure 153A1 and a second void 153A2V of the second bucket structure 153A2 may combine with the first void 173AV of the first shelf structure 173A to provide the first set of optical ports 143A with space for optical fill material that may overfill the first interface 163A between the first optical ports 143A and the first set of bulk optics components 203A.

The photonic device 103 may include a third bucket structure 153B between the second set of optical ports 143A and the second block structure 183B. An inlet of the third bucket structure 153B may adjoin the second void 173BV of the second shelf structure 173B. As such, a third void 153BV of the third bucket structure 153B may combine with the second void 173BV of the second shelf structure 173B to provide the second set of optical ports 143B with space for optical fill material.

For example, when filling the first interface 163A between the first set of optical ports 143A and the first set of bulk optics components 203A with optical fill material, the optical fill material may overfill the first interface 163A, flow into the first void 173AV provided by the first shelf structure 173A, flow from the first void 173AV into the voids 153A1V, 153A2V provided by the bucket structures 153A1, 153A2, and continue toward the second set of optical ports 143B. However, due to the second block structure 183B, such optical fill material is blocked from traversing the second block structure 183B and into the second interface 163B between the second set of optical ports 143B and the second set of bulk optics components 203B. In this manner, the bucket structures 153A1, 153A2 and the second block structure 183B may provide extra tolerance for filling the first interface 163A and may reduce the likelihood of inadvertently applying optical fill material to the second interface 163A in the process.

As shown in FIG. 3B, the bulk semiconductor substrate 113 may have a vertical depth of about 300 μm to about 1000 μm and the dielectric layer 123 may have a vertical depth of about 10 μm to about 15 μm. In various embodiments, the voids 153A1V, 153A2V, 153BV of the bucket structures 153A1, 153A2, 153B and the voids 173AV, 173BV of the shelf structures 173A, 173B may extend vertically through the dielectric top side 123T and through the semiconductor substrate top side 113T to a vertical depth of about 20 μm to about 150 μm. As shown in FIG. 3A, the bucket structures 153A1, 153A2, 153B may extend laterally into the dielectric layer 123 and bulk semiconductor substrate 113 from a dielectric lateral side 123L and corresponding upper portion 113L of the substrate lateral side 113L by about 1000 μm. Furthermore, the bucket structures 153A1, 153A2, 153B may extend longitudinal along the dielectric lateral side 123L and upper portion 113UL of the substrate lateral side 113L by about 280 μm.

In general, the voids 173AV, 173BV provided by the shelf structures 173A, 173B and the voids 153A1V, 153A2V, 153BV provided by the bucket structures 153A1, 153A2, 153B are made as large as possible for given space constraints. However, there are practical upper and lower limits for such dimensions. For example, dimensions greater than 2000 μm may create mechanical stability concerns. For example, if the voids 153A1V, 153A2V, 153BV, 173AV, 173BV are too large, the photonic device 103 may become prone to cracking. Conversely, if the voids 153A1V, 153A2V, 153BV, 173AV, 173BV are too small, then the voids 153A1V, 153A2V, 153BV, 173AV, 173BV may provide an insufficient volume for a desired level of overflow protection.

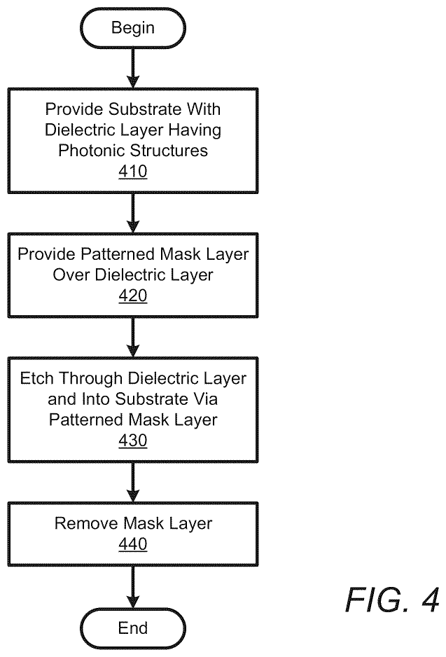

Aspects of an example manufacturing method 400 will be described with reference to the flowchart of FIG. 4 and the photonic device 103 of FIGS. 3A and 3B. However, a similar manufacturing method may be used to fabricate the photonic devices 101, 102 of FIGS. 1A and 2A.

At 410, the manufacturing method 400 may include providing a bulk semiconductor substrate 113 comprising a dielectric layer 123 with photonic structures 133 and sets of optical ports 143A, 143B. In some embodiments, the manufacturing method 400 at 410 may perform all aspects of fabricating the photonic structures 133 and sets of optical ports 143A, 143B. In other embodiments, the bulk semiconductor substrate 113 and/or dielectric layer 123 may be received at various stages of fabrication (e.g., with one or more photonic structures 133 and/or sets of optical ports 143A, 143B already formed) and the manufacturing method 400 at 410 may include completing the remaining fabrication steps of forming the photonic structures 133 and/or optical ports 143A, 143B.

At 420, the manufacturing method 400 may include providing a mask over the dielectric top side 123T. To this end, the manufacturing method 400 may form a mask layer over the dielectric top side 123T and use photolithography techniques to pattern the mask layer such that the mask layer exposes areas of the dielectric top side 123T corresponding to the bucket structures 153A1, 153A2, 153B and the shelf structures 173A, 173B.

The manufacturing method 400 at 430 may etch away the exposed portions of the dielectric top side 123T and into the semiconductor substrate top side 113T. Such etching may form the voids 153A1V, 153A2V, 153B provided by the bucket structures 153A1, 153A2, 153B through the dielectric layer 123 and into the bulk semiconductor substrate 113. Moreover, such etching may form the voids 173AV, 173BV provided by the shelf structures 173A, 173B through the dielectric layer 123 and into the bulk semiconductor substrate 113. Further, such etching may leave the voids 173AV, 173BV of the shelf structures 173A, 173B separated from one another by portions of the dielectric layer 123 and the bulk semiconductor substrate 113, which form the block structures 183A, 183B.

The manufacturing method 400 at 440 may remove the mask from the dielectric top side 123T to obtain the photonic device 103 of FIGS. 3A and 3B. In particular, the mask may be removed via etching, grinding, stripping, and/or some other removal process.

The present disclosure includes reference to certain examples, however, it will be understood by those skilled in the art that various changes may be made and equivalents may be substituted without departing from the scope of the disclosure. In addition, modifications may be made to the disclosed examples without departing from the scope of the present disclosure. Therefore, it is intended that the present disclosure not be limited to the examples disclosed, but that the disclosure will include all examples falling within the scope of the appended claims.

What is claimed is:

1. A photonic device, comprising:
a semiconductor substrate comprising a substrate top side, a substrate bottom side, a substrate lateral side between the substrate top side and the substrate bottom side;
a dielectric layer on the substrate top side, wherein the dielectric layer comprises a dielectric top side, a dielectric bottom side, a dielectric lateral side between the dielectric top side and the dielectric bottom side;
a first set of optical ports in the dielectric layer and positioned along the dielectric lateral side;
a second set of optical ports in the dielectric layer and positioned along the dielectric lateral side; and
one or more overflow structures between the first set of optical ports and the second set of optical ports, wherein the one or more overflow structures provide one or more voids configured to receive optical fill material that overflows from its application to the first set of optical ports.

2. The photonic device of claim 1, wherein:
each optical port of the first set of optical ports is designed to interface bulk optics components via optical fill material; and
each optical port of the second set of optical ports is designed to interface bulk optics components free of optical fill material.

3. The photonic device of claim 1, wherein:
the one or more overflow structures comprises a bucket structure between the first set of optical ports and the second set of optical ports; and
the bucket structure provides a first void to receive optical fill material when overflowing from its application to the first set of optical ports.

4. The photonic device of claim 3, wherein:
the one or more overflow structures comprises a first shelf structure below the first set of optical ports; and
the first shelf structure provides a first void below the first set of optical ports that is configured to receive optical fill material when overflowing from its application to the first set of optical ports.

5. The photonic device of claim 4, wherein:
the one or more overflow structures comprises a second shelf structure below the second set of optical ports; and
the second shelf structure provides a second void below the second set of optical ports.

6. The photonic device of claim 5, wherein the one or more overflow structures comprises a block structure that separates the first void provided by first shelf structure from the second void provided by the second shelf structure.

7. The photonic device of claim 4, wherein:
the one or more overflow structures comprises a bucket structure between the first set of optical ports and the second set of optical ports;
the bucket structure provides a second void to receive optical fill material when applied to the first set of optical ports; and
the bucket structure comprises an inlet that couples the second void provided by the bucket structure to the first void provided by the first shelf structure.

8. The photonic device of claim 7, wherein:
the one or more overflow structures comprises a second shelf structure below the second set of optical ports; and
the second shelf structure provides a third void below the second set of optical ports.

9. The photonic device of claim 8, wherein the one or more overflow structures comprises a block structure that separates the first void provided by first shelf structure from the third void provided by the second shelf structure.

10. A photonic system, comprising:
a photonic device comprising:
a semiconductor substrate comprising a substrate top side, a substrate bottom side, a substrate lateral side between the substrate top side and the substrate bottom side;
a dielectric layer on the substrate top side, wherein the dielectric layer comprises a dielectric top side, a dielectric bottom side, a dielectric lateral side between the dielectric top side and the dielectric bottom side;
a first set of optical ports in the dielectric layer and positioned along the dielectric lateral side;
a second set of optical ports in the dielectric layer and positioned along the dielectric lateral side; and
one or more overflow structures between the first set of optical ports and the second set of optical ports;
a first set of bulk optics components coupled to the first set of optical ports;
a second set of bulk optics components coupled to the second set of optical ports; and
optical fill material that fills a first interface between the first set of bulk optics components and the first set of optical ports; and
wherein the one or more overflow structures provide one or more voids to receive optical fill material that overflows from the first interface between the first set of bulk optics components and the first set of optical ports.

11. The photonic system of claim 10, wherein a second interface between the second set of bulk optics components and the second set of optical ports remains free of optical fill material.

12. The photonic system of claim 10, wherein:
each optical port of the first set of optical ports is designed to be interfaced with optical fill material; and
each optical port of the second set of optical ports is designed to be free of optical fill material.

13. The photonic system of claim 10, wherein:
the one or more overflow structures comprises a bucket structure between the first set of optical ports and the second set of optical ports; and
the bucket structure provides a first void to receive optical fill material that overflows from the first interface between the first set of optical ports and the first set of bulk optics components.

14. The photonic system of claim 13, wherein:
the one or more overflow structures comprises a first shelf structure below the first set of optical ports; and
the first shelf structure provides a first void below the first set of optical ports that is configured to receive optical fill material that overflows from the first interface between the first set of optical ports and the first set of bulk optics components.

15. The photonic system of claim 14, wherein:
the one or more overflow structures comprises a second shelf structure below the second set of optical ports; and
the second shelf structure provides a second void below the second set of optical ports.

16. The photonic system of claim 15, wherein the one or more overflow structures comprises a block structure that separates the first void provided by first shelf structure from the second void provided by the second shelf structure.

17. The photonic system of claim 14, wherein:
the one or more overflow structures comprises a bucket structure between the first set of optical ports and the second set of optical ports;
the bucket structure provides a second void to receive optical fill material that overflows from the first interface between the first set of optical ports and the first set of bulk optics components; and
the bucket structure comprises an inlet that couples the second void provided by the bucket structure to the first void provided by the first shelf structure.

18. The photonic system of claim 17, wherein:
the one or more overflow structures comprises a second shelf structure below the second set of optical ports and a block structure between the first shelf structure and the second shelf structure;
the second shelf structure provides a third void below the second set of optical ports; and
the block structure separates the first void provided by first shelf structure from the third void provided by the second shelf structure.

19. The photonic system of claim 10, wherein the optical fill material comprises epoxy or oil.

20. The photonic system of claim 10, wherein the first set of bulk optics components and the second set of bulk optics components each include one or more optical fibers, lenses, or prisms.
